(19) United States
(12) Patent Application Publication
(10) Pub. No.: US 2011/0138699 A1
(43) Pub. Date: Jun. 16, 2011

(54) RESCUE KIT FOR A WIND TURBINE, A WALL FOR A WIND TURBINE, AND A PORTION OF A COMPARTMENT OF A WIND TURBINE

(76) Inventors: Thomas Niehues, Neuenkirchen (DE); Ralf Bernd Huelsing, Salzbergen (DE)

(21) Appl. No.: 12/825,732

(22) Filed: Jun. 29, 2010

(51) Int. Cl. A62B 35/00; A62B 1/06; E04H 12/00

(52) U.S. Cl. 52/40; 182/5

(57) ABSTRACT

The present disclosure relates to a rescue kit for a wind turbine, the rescue kit including at least one flame resistant descent device including at least one flame resistant rope. Further, the present disclosure relates to a wall for a wind turbine, the wall having a first side adapted to be directed to a first space and a second side adapted to be directed to a second space different from the first space, wherein the wall includes at least one box for a rescue kit. Additionally, the present disclosure relates to a compartment portion of the wind turbine, the portion of the wind turbine including a rescue kit, including at least one flame resistant descent device, including at least one flame resistant rope.

### BACKGROUND OF THE INVENTION

The present disclosure relates to a rescue kit for a wind turbine. Further, the present disclosure relates to a wall for a wind turbine, in particular the wall having a first side adapted to be directed to a first space and a second side adapted to be directed to a second space different from the first space. Additionally, the present disclosure relates to a portion of a compartment of the wind turbine.

Typically, when wind turbines have a nacelle, it is typically disposed on the top of a tower. In some embodiments, the tower height may be between 50 and 200 meter. Typically, it is difficult to extinguish a fire in the nacelle from the ground. Further, official regulations, for example European rules and standards, require that escape routes maintain a function for at least 30 minutes in the event of fire. Thus, a person in the nacelle may be able, to escape from the fire.

### BRIEF DESCRIPTION OF THE INVENTION

In view of the above, a rescue kit for a wind turbine is provided, including at least one fire resistant descent device including at least one flame resistant rope.

According to a further embodiment, a wall for a wind turbine is provided, the wall having a first side adapted to be directed to a first space and a second side adapted to be directed to a second space different from the first space, wherein the wall includes at least one box for a rescue kit.

According to another embodiment, a compartment portion of the wind turbine is provided, the portion of the wind turbine including a rescue kit, including at least one fire resistant descent device, including at least one flame resistant rope.

Further aspects, advantages and features of the present invention are apparent from the dependent claims, the description and the accompanying drawings.

### BRIEF DESCRIPTION OF THE DRAWINGS

A full and enabling disclosure including the best mode thereof, to one of ordinary skill in the art, is set forth more particularly in the remainder of the specification, including reference to the accompanying figures wherein:

FIG. 1 schematically shows an embodiment of a wind turbine;

FIG. 2 schematically shows an embodiment of a nacelle of a wind turbine;

FIG. 3 schematically shows an embodiment of a box for a rescue kit;

FIG. 4 shows a schematically cross-section of an embodiment of a box for a rescue kit; and

FIG. 5 shows schematically a cross section of an embodiment of a tower of a wind turbine.

### DETAILED DESCRIPTION OF THE INVENTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with other embodiments to yield yet further embodiments. It is intended that the present disclosure includes such modifications and variations.

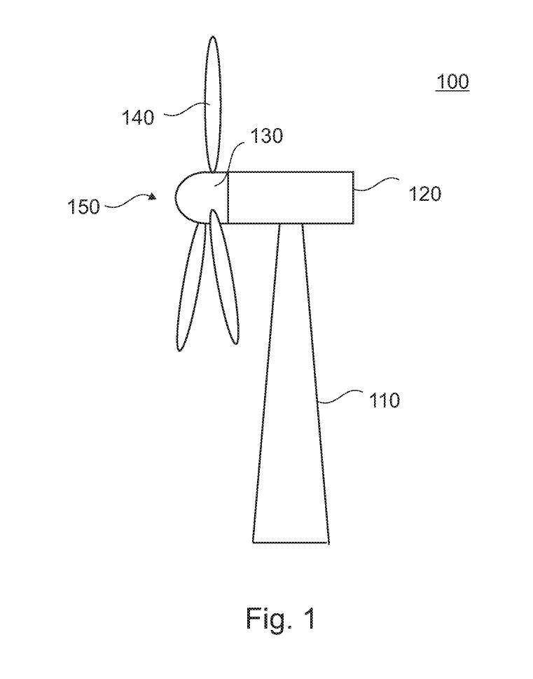

FIG. 1 shows a wind turbine 100. The wind turbine 100 includes a tower 110 on which a nacelle 120 is mounted. The nacelle 120 is rotatable about a vertical axis of the tower. Within the nacelle 120, a generator (not shown) for transforming rotational energy into electrical energy is placed. The generator is connected to a hub 130 that is rotatable about a horizontal axis. Three rotor blades 140 are connected to the hub 130. The rotor blades 140 and the hub 130 together form a wind rotor of the wind turbine 100. The wind turbine 100 operates as follows. In a typical situation, the nacelle 120 is rotated about the vertical axis such that the horizontal axis of the hub 130 is approximately parallel to a wind direction. The wind exerts a torque on the wind rotor due to an aerodynamical profile of the rotor blades 140. Accordingly, the wind rotor rotates about its horizontal axis, thus driving the generator. The generator transforms the mechanical rotation into an electric current. Hence, the kinetic energy of the wind is transformed into electric energy. In a typical embodiment, the present disclosure may also relate to offshore-wind turbines.

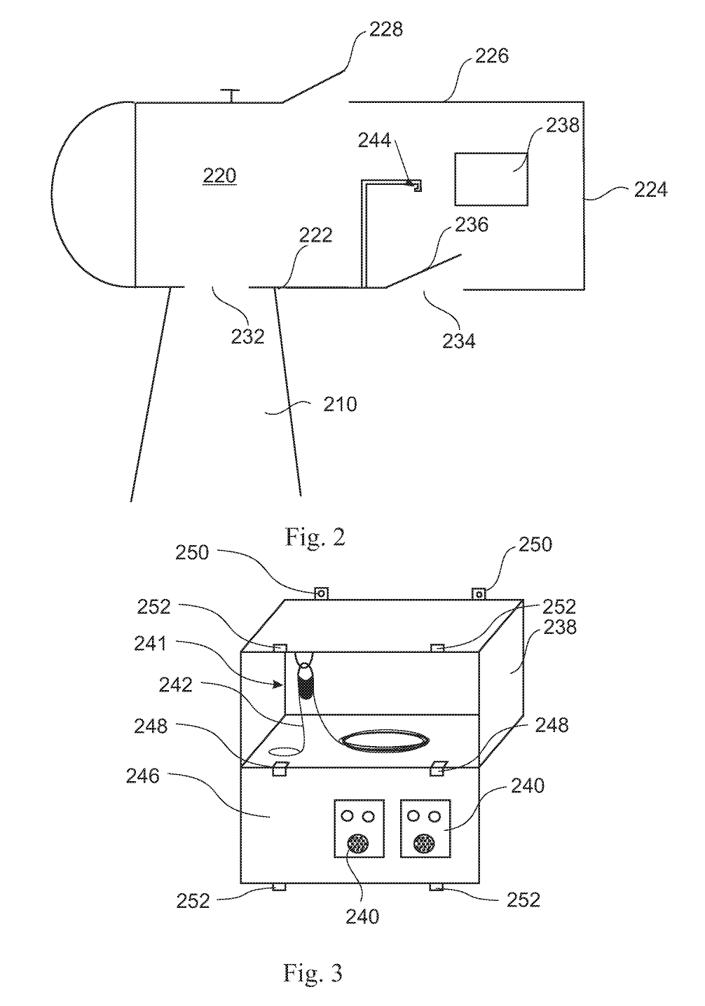

FIG. 2 shows a cross sectional view of a nacelle of a wind turbine. Typically, the nacelle 220 is disposed on an upper end of a wind turbine tower 210. The nacelle includes a nacelle floor 222, a nacelle sidewall 224 and a nacelle ceiling 226. Typically at least one measurement device 230, for example an anemometer and/or a temperature sensing device, is disposed on an exterior side of the nacelle ceiling. For that reason, the nacelle ceiling 226 may include a first hatch 228, such that service staff may access the at least one measurement device 230 on the exterior side of the ceiling 226. Further, the nacelle floor may include a first opening 232 through which a person, for example a service staff may enter from the tower 210 into the nacelle 220. For example, a person may enter the nacelle 220 using a lift or a ladder. Further, the nacelle may include, at a position of the floor which is not above the tower 210, a second opening 234 which may be opened or closed in a typical embodiment by a second hatch 236. In a typical embodiment, the second hatch 236 may be opened such that material for repairing the wind turbine or other maintenance equipment may be lifted into the nacelle 220. Further, the nacelle may include a flame resistant box 238 which may include a flame resistant rescue kit for escaping from the nacelle 220 in case of a fire or another emergency event. In a further embodiment, which may be combined with other embodiments disclosed herein, the wind turbine may include a flame resistant box for a flame resistant rescue kit within the tower, for example at different heights of the tower.

FIG. 3 shows a box 238 for a flame resistant rescue kit. The box may be flame resistant. In a typical embodiment, the box may be mounted on a wall, for example the sidewall 224 of the nacelle or the wall of the tower 210, 110 of the wind turbine 100. In a typical embodiment, the box for the rescue equipment is closed and sealed during normal operation of the wind turbine. Thus, if the seal is not broken, the maintenance staff can easily check if the rescue equipment in the box for the flame resistant rescue kit is still complete. Typically, the maintenance staff can see that the safety kit is ready for use. In a typical embodiment, as shown in FIG. 3, the flame resistant rescue kit may include one or more, for example two, fire escape hoods. Typically, a fire escape hood is put on the head of a person and a cord of the fire escape hood may seal the interior of the fire escape hood against the exterior environment. A fire escape hood may filter the air for a predetermined amount of time, for example at least about 30 minutes, typically at least about 60 minutes, using a purifier canister or cartridge. Thus, a person may breathe in a smoke contaminated environment, for example, for more than about 30 minutes or, typically, more than about 60 minutes. Further, a fire escape hood may include a visor for providing a clear view. Further, in an embodiment, the flame resistant rescue kit includes a descent device 241 including a flame resistant rope 242 for safely climbing in the event of a fire. In a typical embodiment, the flame resistant rope 242 may include fiber glass. In embodiments, which may be combined with other embodiments disclosed herein, the flame resistant rope may include aramid or para-aramid fiber. In a typical embodiment, in case of an emergency event, the fire resistant rope 242 may be connected to an anchor point 244, in a typical embodiment within the nacelle, which may be arranged close to the second opening 234 in the floor 222 of the nacelle 220. In another embodiment, the fire resistant rope 242 may be already connected to an anchor point, such that the fire resistant rope may not be fixed, in the event of emergency by a person. For example, the anchor point may be close to the box 238 or inside the box 238.

In a typical embodiment, which may be combined with other embodiments disclosed herein, the box 238 is fabricated from a fire or flame resistant material or a less inflammable material. In an embodiment, the box may be an aluminum box. Typically, the box includes the decent device 241 including the flame or fire resistant rope 242. For example, the box may be closed by a cover 246 which is connected to the box with at least one hinge 248. In an embodiment, which may be combined with other embodiments disclosed herein, the at least one fire escape hood 240 is attached to the cover 246. For mounting the fire resistant box 238 to a wall, the box 238 may include, in a typical embodiment, at least one fastener 250. In a further embodiment, which may be combined with other embodiments disclosed herein, the box, in particular the cover 246, may include locks 252, which may be secured with a seal, such that it may be easily determined, if the box 238 has been opened. In a typical embodiment, the box may be mounted in the range of the anchor point 244. Typically, the fire escape hoods 240 allow the breathing in smoke contaminated environment, such that a maintenance staff person may be able to rig up the decent device with the rope 242. Thus, the flame resistant rescue kit allows safe escape from the nacelle in the event of fire.

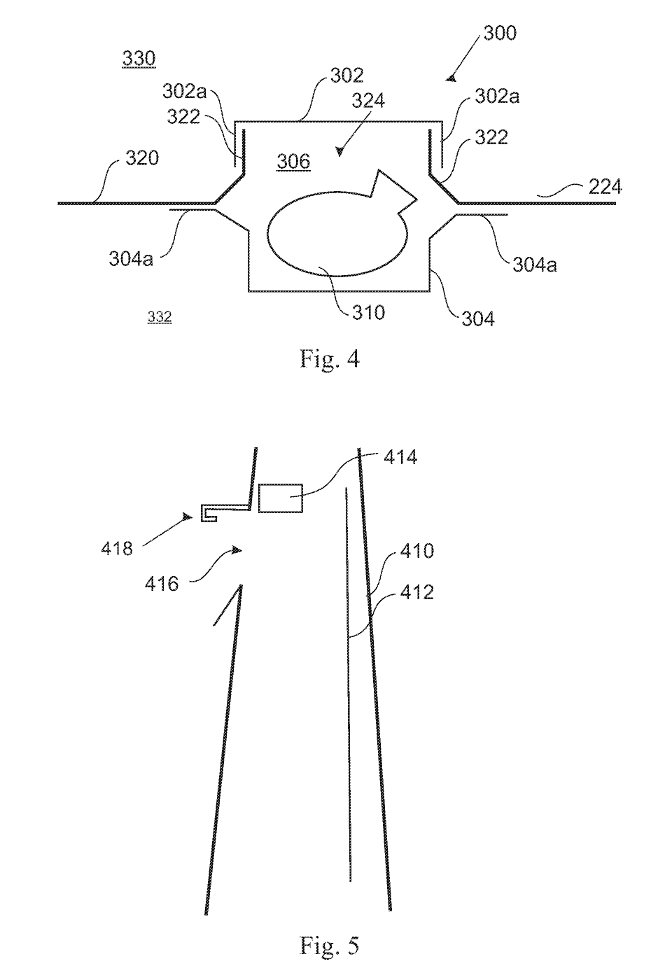

FIG. 4 shows schematically a cross-sectional view of an embodiment of a box 300 for a flame resistant rescue kit. In a typical embodiment, which may be combined with other embodiments disclosed herein, the flame resistant rescue kit may include a fire resistant decent device, for example including a fire resistant rope, and/or at least one fire escape hood. In a typical embodiment, the rescue kit may be provided in a bag 310 within the box 300. Typically, the box 300 is provided in the ceiling 320 of the nacelle. Typically the ceiling 320 separates an exterior 330 from an interior 332 of the nacelle. In a further embodiment, the box may be provided in a wall of the nacelle. In another embodiment, which may be combined with other embodiments disclosed herein, the box may be provided in a wall of a tower of the wind turbine, a wall of another compartment of the wind turbine, or a wall of a discrete compartment. In a typical embodiment, which may be combined with other embodiments disclosed herein, the rescue kit and/or the box may be disposed at the generator frame.

According to a typical embodiment, the interior of the box 300 is accessible for the interior 332 and from the exterior 330 of the nacelle or the tower. Typically, two spaces 330, 332, in particular an exterior space and an interior space, which are separated by a wall, in particular the ceiling 320 of the nacelle, may have access to the box 300. Typically, the interior of the box 300 is limited by an exterior lid 302, at least one portion 322 of the ceiling 320 and/or an interior lid 304. In another embodiment, the interior lid of the box 300 may be substantially only limited by the first lid 302 and the second lid 304.

The ceiling of the nacelle 226 includes an opening 324 which is closed from the exterior side 330 of the nacelle 220 by the exterior lid 302 and from the interior side 332 by the second or interior lid 306. Thus, a space or box is formed by the exterior lid 302, a portion of the ceiling 226 of the nacelle and the interior lid 306. In the box 308, a fire or flame resistant rescue kit 310 is disposed including a fire resistant decent device including a fire resistant rope, and at least one fire escape hood. In a typical embodiment, the at least one portion 322 of the ceiling 320 is bent upwards to form a flange, such that the interior 306 of the box 300 is weather proof Which such a box, the bag 310 including the fire or flame resistant rescue kit is available from the interior side 332 of the ceiling 320 of the nacelle and from the exterior side 330 of ceiling 320 of the nacelle, for example if a maintenance staff is working on the nacelle, for example for repairing the anemometer or another measurement device. The exterior lid 302 and the interior lid 304 are releasably connected to the ceiling 226, such that they may be easily opened by the maintenance staff or other person in or on the nacelle. For example, the exterior lid 302 and the interior lid may respectively include a flange 302a, 304a that may be used to connect the respective lid 302, 304 to the ceiling 320. For example the flange may be formed, such that it is in parallel to the ceiling 320, adjacent to the opening 324, or perpendicular to the ceiling 320, such that the flange 302a of the respective lid 302 may be fixed to the flange 322 of the ceiling. In a typical embodiment, the flange 322 of the ceiling may surround the opening 324 in the ceiling.

Typically, the length of the fire resistance rope corresponds substantially to the height to be used to rope down, for example it may correspond to the height of the tower of the wind turbine. With flame resistant it is meant, that the rope, the descent device, and/or the rescue kit withstands fire for at least 15 minutes, for example more than 30 minutes and/or at least the time needed to climb down the flame resistant rope. For example, one or two persons may need 20 minutes to climb down and reach the ground from the nacelle. Thus, the staff may have enough time to escape in case of a fire in the nacelle or in the tower.

FIG. 5 schematically shows a cross-sectional view of an embodiment of a tower 410 of a wind turbine. The tower may include a ladder 412, which may be used to access the nacelle of the wind turbine or to climb up and down in the tower 410. In a typical embodiment, a box 414 for a flame resistant rescue kit may be provided in the tower 410, in particular near to an opening 416 through which a person may be evacuated. Further, in a typical embodiment, an anchor point 418 for a rescue rope may be provided, such that a person may easily climb down from the opening 416 in the tower.

In a typical embodiment, the rescue kit may be used as a personal equipment, in particular for a person working in the nacelle.

In a typical embodiment, which may be combined with other embodiments, the rescue kit may further include at least one fire escape hood.

For example, in an embodiment, the at least one flame resistant rope is adapted to withstand fire for at least about 15 minutes. In a typical embodiment, the at least one flame resistant rope is adapted to withstand fire for at least about 30 minutes.

In a typical embodiment, which may be combined with other embodiments disclosed herein, the flame resistant rescue kit may include a box, in particular a flame resistant box, wherein the at least one flame resistant descent device, and/or the at least one fire escape hood are disposed in the box.

In a typical embodiment, which may be combined with other embodiments disclosed herein, the wall is one selected of the group consisting of: a wall of a nacelle of a wind turbine, a wall of a compartment of a wind turbine, a wall of a discrete cell of a wind turbine, the floor of a nacelle of a wind turbine, the ceiling of a nacelle of a wind turbine, an intermediate wall of a nacelle of a wind turbine, and a wall of a tower of a wind turbine.

For example, in embodiment, the box includes at least one of the group consisting of: at least one flame resistant descent device, a flame resistant rope, and at least one fire escape hood.

In a further embodiment, the wall may include an opening, wherein the box is disposed in the opening.

Typically, in an embodiment, which may be combined with other embodiments disclosed herein, the interior of the box is adapted to be accessible from the first space and the second space.

For example, in an embodiment, the storage box may include at least one first lid for selectively permitting and preventing access to the interior of the box from the first space, and at least one second lid for selectively permitting and preventing access to the interior of the box from the second space. In a typical embodiment, the box is flame resistant.

In an embodiment, which may be combined with other embodiments disclosed herein, the compartment of the wind turbine is selected of the group consisting of a tower section of the wind turbine, and a nacelle of the wind turbine.

In a typical embodiment, the portion of a compartment of a wind turbine may include a support device for fixing the flame resistant rope thereto, wherein the support device is disposed such that a person may rappel from the portion of the wind turbine. In a typical embodiment, the flame resistant rescue kit further includes at least one fire escape hood. In an embodiment, the portion of a compartment may include a box, in particular a flame resistant box or a less inflammable box, wherein at least one is disposed therein of the group consisting of: the at least one flame resistant rope and the at least one fire escape hood. In a typical embodiment, the box is adapted to be sealed.

This written description uses examples to disclose the invention, including the best mode, and also to enable any person skilled in the art to practice the described subject-matter, including making and using any devices or systems and performing any incorporated methods. While various specific embodiments have been disclosed in the foregoing, those skilled in the art will recognize that the spirit and scope of the claims allows for equally effective modifications. Especially, mutually non-exclusive features of the embodiments described above may be combined with each other. The patentable scope is defined by the claims, and may include such modifications and other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A rescue kit for a wind turbine, the rescue kit comprising
at least one flame resistant descent device including at least one flame resistant rope.

2. The rescue kit according to claim 1, further comprising
at least one fire escape hood.

3. The rescue kit according to claim 1, wherein
the at least one flame resistant rope is adapted to withstand fire for at least about 15 minutes.

4. The rescue kit according to claim 1, wherein
the at least one flame resistant rope is adapted to withstand fire for at least the time needed to climb down the flame resistant rope.

5. The rescue kit according to claim 1, further comprising
a box, wherein at least one of the at least one flame resistant descent device, and
the at least one fire escape hood is disposed in the box.

6. The rescue kit according to claim 5, wherein
the box is sealed.

7. A wall for a wind turbine, the wall having a first side adapted to be directed to a first space and a second side adapted to be directed to a second space different from the first space, wherein
the wall comprises at least one box for a rescue kit.

8. The wall for a wind turbine according to claim 7, wherein
the wall is one selected of the group consisting of: a wall of a nacelle of a wind turbine, a wall of a compartment of a wind turbine, a wall of a discrete cell of a wind turbine, the floor of a nacelle of a wind turbine, the ceiling of a nacelle of a wind turbine, an intermediate wall of a nacelle of a wind turbine, and a wall of a tower of a wind turbine.

9. The wall for a wind turbine according to claim 7, wherein
the box includes at least one of the group consisting of: at least one flame resistant descent device, a flame resistant rope, and at least one fire escape hood.

10. The wall for a wind turbine according to claim 7, wherein
the wall includes an opening, wherein the box is disposed in the opening.

11. The wall for a wind turbine according to claim 7, wherein
the interior of the box is adapted to be accessible from the first space and the second space.

12. The wall for a wind turbine according to claim 11, wherein
the box comprises at least one first lid for selectively permitting and preventing access to the interior of the box from the first space, and at least one second lid for selectively permitting and preventing access to the interior of the box from the second space.

13. The wall for a wind turbine according to claim 7, wherein
the box is flame resistant.

14. A compartment portion of the wind turbine,
the compartment portion comprising a rescue kit, including at least one flame resistant descent device, including at least one flame resistant rope.

15. The compartment portion of the wind turbine according to claim 14, wherein
the compartment of the wind turbine is selected of the group consisting of a tower section of the wind turbine, and a nacelle of the wind turbine.

16. The compartment portion of the wind turbine according to claim 14 further comprising
a support device for fixing the flame resistant rope thereto, wherein the support device is disposed such that a person may rappel from the portion of the wind turbine.

17. The compartment portion of the wind turbine according to claim 14, wherein
the rescue kit further comprises at least one fire escape hood.

18. The compartment portion of the wind turbine according to claim 14, further comprising
a box, wherein at least one is disposed therein of the group consisting of: the at least one flame resistant rope and the at least one fire escape hood.

19. The compartment portion of the wind turbine according to claim 18, wherein
the box is flame resistant.

20. The compartment portion of the wind turbine according to claim 14, wherein
the box is adapted to be sealed.
